(19) United States
(12) Patent Application Publication
(10) Pub. No.: US 2021/0246318 A1
(43) Pub. Date: Aug. 12, 2021

(54) ANTIBACTERIAL FILM STRUCTURE

(71) Applicant: Yuyangxi (Xiamen) New Material Technology Co., Ltd., Xiamen (CN)

(72) Inventors: Chin-Wang Lee, Tainan City (TW); Chung-Ping Chou, Tainan City (TW)

(21) Appl. No.: 17/170,238

(22) Filed: Feb. 8, 2021

(30) Foreign Application Priority Data
Feb. 7, 2020 (TW) 109103912

(51) Int. Cl. C09D 5/14; C09D 5/00; C09D 7/63; C09D 7/61; A01N 25/08; A01N 59/16

(52) U.S. Cl. CPC C09D 5/14; C09D 5/00; A01N 59/16; C09D 7/61; A01N 25/08; C09D 7/63

(57) ABSTRACT

The present disclosure discloses an antibacterial film structure. The antibacterial film structure comprises a silica base layer, an organic hydrophilic antibacterial layer, and a silica protective layer. The organic hydrophilic antibacterial layer is disposed on the silica base layer, and the silica protective layer is disposed on the organic hydrophilic antibacterial layer.

### RELATED APPLICATIONS

This application claims priority to Taiwan patent application number 109103912, filed Feb. 7, 2020. Taiwan patent application number 109103912 is incorporated herein by reference.

### FIELD OF THE DISCLOSURE

The present disclosure relates to an antibacterial film structure, and in particular relates to an antibacterial, anti-fingerprint, and waterproof multilayer structure.

### BACKGROUND OF THE DISCLOSURE

TW I636146B discloses a functional film, a film forming method for forming the functional film, and an antibacterial and anti-fingerprint component. The film forming method uses a physical co-plating method to form the functional film in which the functional film is formed by a first material and a second material plating on a substrate. The function film has antibacterial and anti-fingerprint properties. The first material to be plated comprises an antibacterial compound, and the second material to be plated comprises an anti-fingerprint compound. The functional film has antibacterial and anti-fingerprint properties, and the antibacterial and anti-fingerprint component comprises the functional film. However, the functional film does not have a waterproof function.

### BRIEF SUMMARY OF THE DISCLOSURE

In order to solve the technical problems of the existing techniques, the present disclosure provides an antibacterial film structure that is antibacterial, anti-fingerprint, and waterproof.

A technical solution of the present disclosure is as follows.

An antibacterial film structure comprises a silica base layer, an organic hydrophilic antibacterial layer, and a silica protective layer. The organic hydrophilic antibacterial layer is disposed on the silica base layer, and the silica protective layer is disposed on the organic hydrophilic antibacterial layer.

In a preferred embodiment, the silica base layer is disposed on a bottom layer, and a binding force modification surface is disposed on the bottom layer. For example, a surface of the bottom layer is modified to define the binding force modification surface using plasma, radio frequency, or an ion source.

In a preferred embodiment, a thickness of the silica base layer is 5 nm-20 nm.

In a preferred embodiment, a thickness of the organic hydrophilic antibacterial layer is 20 nm-40 nm. For example, an antibacterial component reacts with the silica base layer to define the organic hydrophilic antibacterial layer at a temperature of 60° C.-150° C. and in a pressure of 10⁻⁵ to 10⁻³ atm.

In a preferred embodiment, the organic hydrophilic antibacterial layer is cleaned using plasma technology.

In a preferred embodiment, a thickness of the silica protective layer is 2 nm to 5 nm.

In a preferred embodiment, an anti-fingerprint AF (anti-fingerprint)/AS (anti-scratch) layer is disposed on the silica protective layer

In a preferred embodiment, the silica protective layer is partially scattered on the organic hydrophilic antibacterial layer to define a hydrophilic area and a hydrophobic area. A first portion of the organic hydrophilic antibacterial layer disposed with the silica protective layer defines the hydrophobic area, and a second portion of the organic hydrophilic antibacterial layer not disposed with the silica protective layer defines the hydrophilic area.

In a preferred embodiment, the organic hydrophilic antibacterial layer comprises organic zinc.

In a preferred embodiment, the silica base layer defines a three-dimensional structure. For example, the silica base layer defines an irregular wave shape.

In a preferred embodiment, the bottom layer is made of at least one of plastic, metal, glass, or ceramic, and the plastic comprises at least one of polyethylene terephthalate (PET), polyimide (PI), etc.

Compared with the existing techniques, the technical solution has the following advantages.

1. The silica protective layer of the present disclosure is locally dispersed on the organic hydrophilic antibacterial layer and generates a hydrophilic area and a hydrophobic area. The hydrophobic area can effectively prevent the organic hydrophilic antibacterial layer from falling off due to being exposed to external water, cleaning agents, scraping, etc. As the hydrophilic area is not deposited with the silica protective layer, when external articles or skin touches the hydrophilic area, the external articles or skin will contact the organic hydrophilic antibacterial layer through capillary phenomena to achieve sterilization effects.

2. The silica base layer of the present disclosure is provided to facilitate the combination of the bottom layer and the organic hydrophilic antibacterial layer.

3. The existing techniques generally uses nano-silver as an antibacterial formula, while the organic hydrophilic antibacterial layer of the present disclosure uses a skin-friendly natural antibacterial formula.

4. The organic hydrophilic antibacterial layer of the present disclosure comprises organic zinc. The positively charged zinc ions attract negatively charged bacteria and other microorganisms, and the zinc ions destroy the cell membrane of the bacteria and other microorganisms, causing the bacteria to lose activity or even die, thereby achieving the antibacterial purpose.

5. The antibacterial film structure has antibacterial, anti-fingerprint, anti-contamination, and waterproof properties.

### BRIEF DESCRIPTION OF THE DRAWINGS

FIG. 1 illustrates a flow chart of a manufacturing process of an antibacterial film structure of an embodiment of the present disclosure.

FIG. 2 illustrates a perspective view of the antibacterial film structure of the embodiment.

FIG. 3 illustrates a top view of a silica protective layer of the antibacterial film structure of the embodiment.

FIG. 4 illustrates a schematic view when an organic hydrophilic antibacterial layer of the antibacterial film structure of the embodiment attracts bacteria.

FIG. 5 illustrates a schematic view when the organic hydrophilic antibacterial layer of the antibacterial film structure of the embodiment destroys the bacteria.

FIG. 6 illustrates a schematic view when a water drop is disposed on an anti-fingerprint AF (anti-fingerprint)/AS (anti-scratch) layer of the antibacterial film structure of the embodiment.

FIG. 7 is a resulting photo of an antibacterial test of the antibacterial film structure of the embodiment using a Parallel streak method, which refers to AATCC-147, a sample size is 1 inch×2 inches, a test strain is Escherichia coli (E. coli) (ATCC25922), an inoculation concentration is 1.5*10⁵ CFU/mL, and a contact period is 24 hours.

Reference numbers: bottom layer 1, binding force modification surface 2, silica base layer 3, organic hydrophilic antibacterial layer 4, organic zinc 41, silica protective layer 5, hydrophilic area 51, hydrophobic area 52, anti-fingerprint AF/AS layer 6, bacterium 7, water drop 8, angle θ.

### DETAILED DESCRIPTION OF THE EMBODIMENTS

The present disclosure will be further described below in combination with the accompanying drawings and embodiments.

Hereinafter, unless otherwise specified and limited, the terms “upper”, “lower”, “front”, “rear”, “left”, “right”, “horizontal”, “vertical”, “top”, “bottom”, “inner”, “outer”, and other directional terms used to refer to directions and positions are based on the directions and the positions of the perspective views of the drawings. The terms do not indicate that the device and the element should be defined or operated in a certain direction or have a certain direction, but are intended to enable the present disclosure to be clearly understood and to simplify the description. Therefore, the present disclosure is not limited thereto.

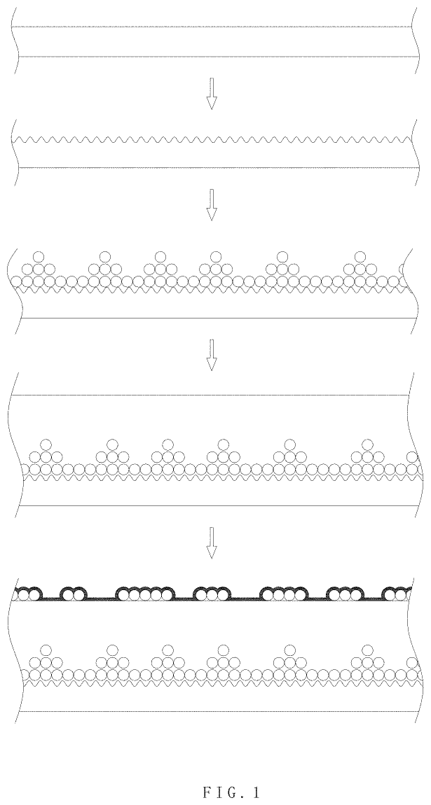

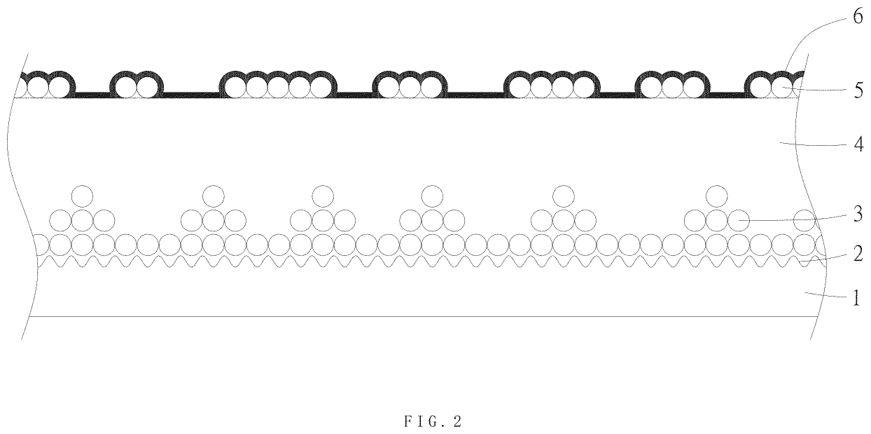

Referring to FIGS. 1 and 2, an antibacterial film structure of this embodiment comprises a bottom layer 1, a binding force modification surface 2, a silica base layer 3, an organic hydrophilic antibacterial layer 4, a silica protective layer 5, and an anti-fingerprint AF (anti-fingerprint)/AS (anti-scratch) layer 6. The organic hydrophilic antibacterial layer 4 is deposited on the silica base layer 3, and the silica protective layer 5 is deposited on the organic hydrophilic antibacterial layer 4.

The bottom layer 1 can be made of plastic, such as polyethylene terephthalate (PET), polyimide (PI), etc., a metal substrate, glass, ceramic, etc., and the bottom layer 1 needs to withstand a temperature above 70° C. A surface of the bottom layer 1 is modified using plasma technology to enable an original smooth surface of the bottom layer 1 to be modified into a porous surface, and the porous surface defines the binding force modification surface 2. Therefore, the binding force modification surface 2 can have a smaller water drop contact angle. Silica is then deposited on the binding force modification surface 2 to define the silica base layer 3 by any one of physical coating methods comprising vapor-deposited coating, chemical vapor deposition (CVD), or physical vapor deposition (PVD). A thickness of the silica base layer 3 is 5 nm-20 nm, and the silica base layer 3 defines a three-dimensional structure.

Referring to FIG. 2, it can be clearly seen that the silica base layer 3 presents irregular waves. The silica base layer 3 is disposed to facilitate a combination between the bottom layer 1 and the subsequent organic hydrophilic antibacterial layer 4 since a material of the bottom layer 1 may not be able to be combined with the organic hydrophilic antibacterial layer 4.

Subsequently, an antibacterial composition is reacted with the silica base layer 3 to define the organic hydrophilic antibacterial layer 4 at a temperature of 60° C.-150° C. and in a pressure of 10⁻⁵-10⁻³ atm. The antibacterial composition comprises an antibacterial and anti-mold agent for preventing fungi growth and an antibacterial and anti-mold agent for preventing gram-negative bacteria growth. A main ingredient of the anti-bacterial and anti-mold agent for preventing fungi growth is, for example, sodium octylbutyl sulfonate. Other ingredients of the anti-bacterial and anti-mold agent for preventing fungi growth comprise at least one of bromine, nitropropylene glycol, chlorine, methyl, hydro isothiazole, or ketones, which are particularly effective for cotton spinning and are suitable for water-based materials and oil-based materials. Ingredients of the anti-bacterial and anti-mold agent for preventing gram-negative bacteria growth comprise, for example, at least one of diethylene glycol or isotridecanol ethoxylate (i.e., comprising diethylene glycol and isotridecanol ethoxylate), which are water-based and are used for preventing gram-negative bacteria growth. The organic hydrophilic antibacterial layer 4 can further comprise organic zinc. A thickness of the organic hydrophilic antibacterial layer 4 is 20 nm-40 nm.

A surface of the organic hydrophilic antibacterial layer 4 is then cleaned to remove grease or dirt on the surface of the organic hydrophilic antibacterial layer 4 using plasma technology, and then silica is deposited on the organic hydrophilic antibacterial layer 4 to define the silica protective layer 5 by any one of physical coating methods comprising vapor-deposited coating, CVD, PVD, etc. A thickness of the silica protective layer 5 is 2 nm-5 nm, and the silica protective layer 5 defines a one-dimensional structure.

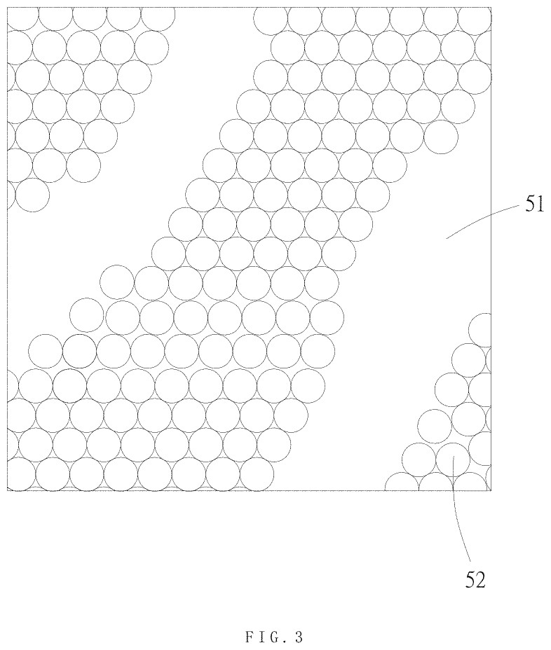

Referring to FIGS. 2 and 3, the deposited silica protective layer 5 is not evenly distributed on the organic hydrophilic antibacterial layer 4 but is partially scattered on the organic hydrophilic antibacterial layer 4 to define a hydrophilic area 51 and a hydrophobic area 52. It can be clearly understandable that the silica protective layer 5 is deposited to define the hydrophobic area 52. The hydrophobic area 52 can effectively prevent the organic hydrophilic antibacterial layer 4 from falling off due to external water, cleaning agents, scraping, etc. The hydrophobic area 52 occupies a large area to ensure that the organic hydrophilic antibacterial layer 4 does not easily fall off. The organic hydrophilic antibacterial layer 4 sterilizes due to the hydrophilic area 51 being not defined by the silica protective layer 5. As the silica protective layer 5 is not deposited on the hydrophilic area 51, external articles or skin will contact the organic hydrophilic antibacterial layer 4 due to capillary phenomena, thereby achieving sterilization effects. When the organic hydrophilic antibacterial layer 4 comprises organic zinc, charge adsorption attraction is generated due to zinc ions, and bacteria is destroyed.

With respect to sterilization effects, FIG. 7 and Table 1 illustrate test results using a Parallel streak method, which refers to AATCC-147. Referring to FIG. 7, a first petri dish A does not have the organic hydrophilic antibacterial layer 4 at all, while a second petri dish B and a third petri dish C define a first sample and a second sample. The first sample and the second sample are both disposed with the organic hydrophilic antibacterial layer 4 of this embodiment.

FIG. 7 and Table 1 clearly show that the organic hydrophilic antibacterial layer 4 has a certain antibacterial effect on bacteria.

TABLE 1
Antibacterial test results against E. coli

| | | |
|---|---|---|
| Antibacterial activity test | AATCC147 | Escherichia coli (ATCC 25922) |

| Inoculation concentration | 1.77*10⁵ | |
|---|---|---|
| (number of bacteria/mL) | | |
| Sample number | color | Antibacterial rate (%) |
| | | E. coli |
| First sample | transparent | no growth |
| Second sample | transparent | no growth |

Referring to Table 2, in order to more clearly understand an efficacy of the antibacterial film structure of the present disclosure, the antibacterial film structure is further tested at an official institution. An antibacterial test is carried out according to the JIS Z2801 standard. There is an experimental group and a control group. An initial value of the number of bacteria in the control group is 1.7*10⁴ CFU/cm², and a LOG value is 4.23. The control group not having the organic hydrophilic antibacterial layer 4 is placed in an environment for 24 hours. The number of bacteria increases to 3.3*10⁴ CFU/cm², and the LOG value is 4.51. The experimental group having the organic hydrophilic antibacterial layer 4 is also placed in the environment for 24 hours. The number of bacteria in the experimental group is less than 0.63 CFU/cm², and the LOG value is −0.20. The experimental data shows that the organic hydrophilic antibacterial layer 4 has good antibacterial effects and bacterial inhibition effects.

TABLE 2
Antibacterial test results against Staphylococcus aureus
Test strain: Staphylococcus aureus (ATCC 6538P)

| | | | antibacterial |
|---|---|---|---|
| Group | CFU/cm² | LOG | activity (R) |
| Control group 0 hours (U₀) | 1.7*10⁴ | 4.23 | >4.71 |
| Control group 24 hours (Uₜ) | 3.3*10⁴ | 4.51 | |
| Experimental group 24 hours (Aₜ) | <0.63 | −0.20 | |

Note: R (log) = Uₜ − Aₜ. When R ≥ 2, the group is considered to have antibacterial activity.

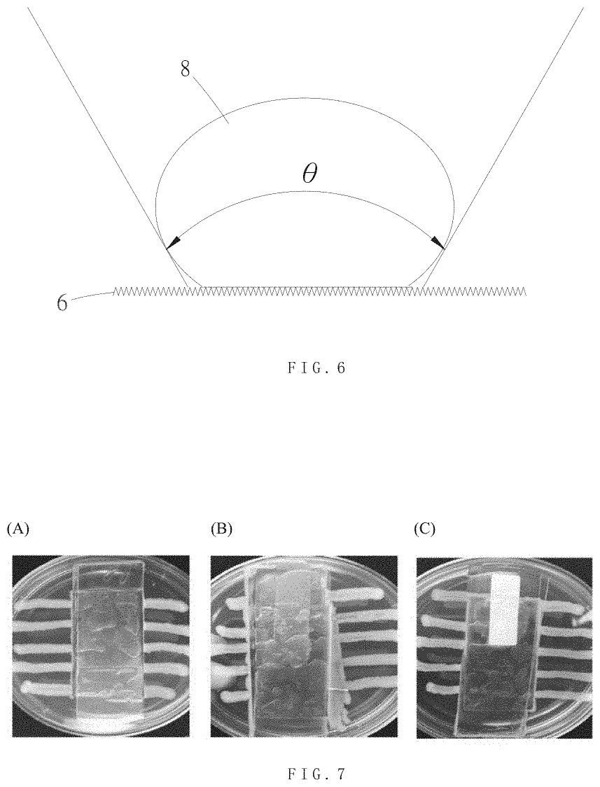

An anti-fingerprint AF/AS layer 6 is further disposed on the silica protective layer 5. Referring to FIG. 6, the anti-fingerprint AF/AS layer 6 comprises an anti-fingerprint compound, and the anti-fingerprint compound is selected from at least one of a compound comprising fluorine, a compound comprising silicon, or a compound comprising fluorine and silicon. The anti-fingerprint AF/AS layer 6 has hydrophobic and oleophobic properties, anti-scratch and anti-fingerprint properties, and a waterproof effect. When a water drop 8 contacts the anti-fingerprint AF/AS layer 6, the water drop 8 will not be pierced, and the anti-fingerprint AF/AS layer 6 and the water drop 8 define an angle θ, which ranges between 100°-150°.

Test results of a scratch resistance test of the antibacterial film structure of this embodiment is shown in Table 3.

TABLE 3
The test results of the scratch resistance test of
the antibacterial film structure with the plastic bottom layer
Basic performance (the bottom layer is made of plastic)

| Items | Methods | Results |
|---|---|---|
| Size | Micrometer | 0.4 mm thickness |
| Transmittance (%) | ASTMD-1003 | >88 |

Hardness and wear resistance

| | | |
|---|---|---|
| Pencil hardness | 750 g load | 6 Hardness (H) − |
| | | 9 Hardness (H) |
| wear resistance | non-woven fabric, 650 g | ≤5 |
| | load, repeated > 1500 | |
| | times | |

Final water contact angle

| | | |
|---|---|---|
| Anti-fingerprint surface | Before wear resistance | ≥110° |
| Anti-fingerprint surface | non-woven fabric, 650 g | ≥90° |
| | load, repeated > 1500 | |
| | times | |

In addition, referring to Table 4, when the bottom layer 1 is made of metal, ceramic, or glass, test results of the scratch resistance test of the antibacterial film structure of this embodiment are provided as references, and an overall hardness can be more than 8 H.

TABLE 4
The test results of the scratch resistance test of
the antibacterial film structure with the metal bottom layer,
the ceramic metal bottom layer, or the glass bottom layer
Basic performance
(the bottom layer is made of metal, ceramic or glass)

| Items | Method | Results |
|---|---|---|
| Size | Micrometer | 0.4 mm thickness |
| Transmittance (%) | ASTMD-1003 | >91 |

Hardness and wear resistance

| | | |
|---|---|---|
| Pencil hardness | 1000 g load | >9H |
| wear resistance | Steel wool, 1000 g load, | ≤5 |
| | repeated > 5000 times | |

Final water contact angle

| | | |
|---|---|---|
| Anti-fingerprint surface | Before wear resistance | ≥110° |
| Anti-fingerprint surface | Steel wool, 1000 g load, | |
| | repeated > 5000 times | ≥100° |

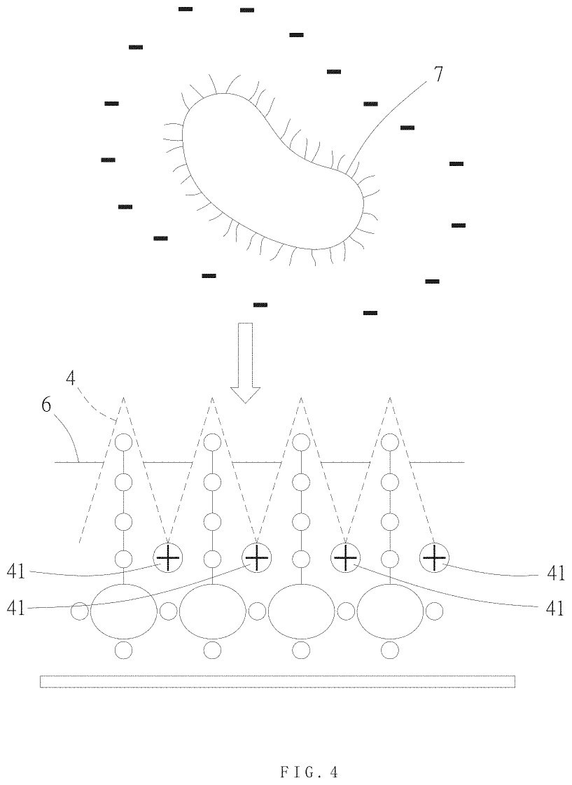

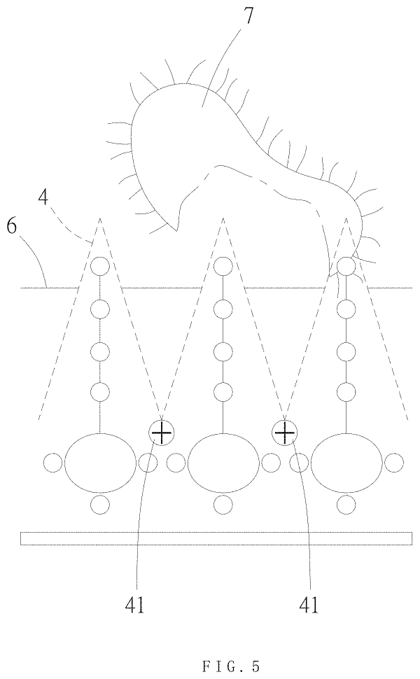

Referring to FIGS. 4 and 5, the organic hydrophilic antibacterial layer 4 comprises organic zinc 41 for adsorbing bacteria or fungi. In this embodiment, it is bacterium 7. In a detailed description, the organic hydrophilic antibacterial layer 4 comprises the organic zinc 41. Under a normal condition, zinc ions of the organic zinc 41 are positively charged. When the bacterium 7 appears, the bacterium 7 is negatively charged and is attracted and destroyed by the positively charged zinc ions. Therefore, the sterilization effects are achieved, and the destroyed bacterium will become carbon dioxide and water.

The aforementioned embodiments are merely some embodiments of the present disclosure, and the scope of the disclosure of is not limited thereto. Thus, it is intended that the present disclosure cover any modifications and variations (i.e., non-substantial variations) of the presently presented embodiments provided they are made without departing from the appended claims and the specification of the present disclosure.

What is claimed is:

1. An antibacterial film structure, comprising:
a silica base layer,
an organic hydrophilic antibacterial layer, and
a silica protective layer, wherein:
the organic hydrophilic antibacterial layer is disposed on the silica base layer, and
the silica protective layer is disposed on the organic hydrophilic antibacterial layer.

2. The antibacterial film structure according to claim 1, wherein:
the silica base layer is disposed on a bottom layer, and
a binding force modification surface is disposed on the bottom layer.

3. The antibacterial film structure according to claim 2, wherein a surface of the bottom layer is modified to define the binding force modification surface using plasma, radio frequency, or an ion source.

4. The antibacterial film structure according to claim 1, wherein a thickness of the silica base layer is 5 nm-20 nm.

5. The antibacterial film structure according to claim 1, wherein a thickness of the organic hydrophilic antibacterial layer is 20 nm-40 nm.

6. The antibacterial film structure according to claim 1, wherein an antibacterial component reacts with the silica base layer to define the organic hydrophilic antibacterial layer at a temperature of 60° C.-150° C. and in a pressure of 10⁻⁵ to 10⁻³ atm.

7. The antibacterial film structure according to claim 1, wherein a thickness of the silica protective layer is 2 nm to 5 nm.

8. The antibacterial film structure according to claim 1, wherein an anti-fingerprint AF (anti-fingerprint)/AS (anti-scratch) layer is disposed on the silica protective layer.

9. The antibacterial film structure according to claim 1, wherein the silica protective layer is partially scattered on the organic hydrophilic antibacterial layer to define a hydrophilic area and a hydrophobic area.

10. The antibacterial film structure according to claim 1, wherein the organic hydrophilic antibacterial layer comprises organic zinc.

11. The antibacterial film structure according to claim 1, wherein the silica base layer defines a three-dimensional structure.

12. The antibacterial film structure according to claim 2, wherein the bottom layer is made of PET (polyethylene terephthalate), PI (polyimide), metal, glass, or ceramic.

13. The antibacterial film structure according to claim 2, wherein a thickness of the silica base layer is 5 nm-20 nm.

14. The antibacterial film structure according to claim 5, wherein an antibacterial component reacts with the silica base layer to define the organic hydrophilic antibacterial layer at a temperature of 60° C.-150° C. and in a pressure of 10⁻⁵ to 10⁻³ atm.
